(19) United States
(12) Patent Application Publication
(10) Pub. No.: US 2012/0242606 A1
(43) Pub. Date: Sep. 27, 2012

(54) TRACE DESIGN FOR REDUCED VISIBILITY IN TOUCH SCREEN DEVICES

(75) Inventor: Bob Lee Mackey, Santa Clara, CA (US)

(73) Assignee: Synaptics Incorporated, Santa Clara, CA (US)

(21) Appl. No.: 13/428,773

(22) Filed: Mar. 23, 2012

Related U.S. Application Data
(60) Provisional application No. 61/466,792, filed on Mar. 23, 2011.

(51) Int. Cl. G06F 3/041

(52) U.S. Cl. 345/173

(57) ABSTRACT

An input device having a plurality of low-visibility sensor electrodes and method for using the same are provided. In one embodiment, an input device includes a display device and a plurality of sensor electrodes disposed over the display device. The sensor electrodes are configured to sense objects in a sensing region of the input device. The sensor electrodes include a plurality of spaced apart conductive traces, each conductive trace having a diameter less than about 10 um. The conductive traces are disposed such that the conductive traces form a moiré pattern with the display device, wherein said moiré pattern comprises a spatial frequency greater than about 10 cycles per centimeter.

### CROSS REFERENCE TO RELATED APPLICATIONS

This application claims benefit of U.S. Provisional Patent Application Ser. No. 61/466,792, filed Mar. 23, 2011, and titled “TRACE DESIGN FOR REDUCED VISIBILITY IN TOUCH SCREEN DEVICES”, which is incorporated by reference in its entirety.

### FIELD OF INVENTION

Embodiments of the invention generally relate to an input device having a plurality of low-visibility sensor electrodes and method sensing an input object using the same.

### BACKGROUND

Input devices including proximity sensor devices (also commonly called touchpads or touch sensor devices) are widely used in a variety of electronic systems. A proximity sensor device typically includes a sensing region, often demarked by a surface, in which the proximity sensor device determines the presence, location and/or motion of one or more input objects. Proximity sensor devices may be used to provide interfaces for the electronic system. For example, proximity sensor devices are often used as input devices for larger computing systems (such as opaque touchpads integrated in, or peripheral to, notebook or desktop computers). Proximity sensor devices are also often used in smaller computer systems (such as touch screens integrated in cellular phones).

Some proximity sensor devices proximity sensor devices utilize microscopic wiring patterns made from opaque conductive materials to form conductive sensor elements. When used over a display of the touch screen, these conductive traces or wires can block some of the pixels or sub-pixels in the display. Certain patterns interfere with the display more than others. For example, if the sensor periodicity is close to the display periodicity, a moiré pattern may be visible when the display is illuminated. Because the eye is more sensitive to some pattern sizes than others, the moiré pattern has a different appearance depending on its size. In the size range of typical displays, small features are less visible. Because of this, fabricators have conventionally attempted to minimize the moiré pattern by reducing the size and width of each conductive trace. Cost effective processing precludes making the conductive traces so small that they cannot be seen under any condition, rendering simple size reduction as an ineffective solution.

Therefore, there is a need for an improved an input device having a plurality of low-visibility sensor electrodes for sensing an input object relative to a sensing region of the input device.

### SUMMARY OF INVENTION

An input device having a plurality of low-visibility sensor electrodes and method for using the same are provided. In one embodiment, an input device includes a display device and a plurality of sensor electrodes disposed over the display device. The sensor electrodes are configured to sense objects in a sensing region of the input device. The sensor electrodes include a plurality of spaced apart conductive traces, each conductive trace having a diameter less than about 10 um. The conductive traces are disposed such that the conductive traces form a moiré pattern with the display device, wherein said moiré pattern comprises a spatial frequency greater than about 10 cycles per centimeter.

In another embodiment, an input device includes a display device and a sensing device. The sensing device has a plurality of first sensor electrodes and a plurality of second sensor electrodes, and is configured to sense objects in a sensing region adjacent the displace device. At least one of the first sensor electrodes and the second sensor electrodes comprise conductive traces having a diameter less than about 10 um. The conductive traces are disposed such that the conductive traces form a moiré pattern with the display device, wherein said moiré pattern comprises a spatial frequency greater than 10 cycles per centimeter.

In yet another embodiment, an input device includes a plurality of sensor electrodes disposed over a display device. The display device includes a plurality of pixels having a first orientation and second orientation orthogonal to the first orientation. The sensor electrodes are configured to sense an object in a sensing region of the input device, wherein the sensor electrodes comprise a plurality of spaced apart conductive traces. Each conductive trace has a diameter less than about 10 um. The conductive traces are oriented relative to plurality of pixels form a moiré pattern with the display device, wherein said moiré pattern comprises a pitch in a direction parallel to the first orientation smaller than the pitch of 3 cycles of pixels.

### BRIEF DESCRIPTION OF DRAWINGS

So that the manner in which the above recited features can be understood in detail, a more particular description, briefly summarized above, may be had by reference to embodiments, some of which are illustrated in the appended drawings. It is to be noted, however, that the appended drawings illustrate only embodiments of the invention and are therefore not to be considered limiting of its scope, for the invention may admit to other equally effective embodiments.

FIG. 1 is a schematic block diagram of an exemplary input device having a sensor device, in accordance with embodiments of the invention.

FIG. 2A is an exploded schematic of one embodiment of the sensor device of FIG. 1 disposed over a display device.

FIG. 2B is a schematic of one embodiment of the sensor device of FIG. 1 illustrating sensor elements disposed at a plurality of rotational angles having a high spatial repeat frequency in relation to a plurality of pixels indicated by subpixels R (red subpixels), G (green subpixels) and B (blue subpixels).

FIG. 3 is a plan view of another embodiment of a sensor electrode of a sensor device.

FIG. 4 is a plan view of another embodiment of a sensor electrode of a sensor device.

FIG. 5 is a plan view of another embodiment of an input device having a sensor device, in accordance with embodiments of the invention.

FIG. 7 an exploded view of an electronic system illustrating various alternative positions of a sensor device.

To facilitate understanding, identical reference numerals have been used, where possible, to designate identical elements that are common to the figures. It is contemplated that elements disclosed in one embodiment may be beneficially utilized on other embodiments without specific recitation.

### DESCRIPTION OF EMBODIMENTS

The following Description of Embodiments is merely provided by way of example and not of limitation. Furthermore, there is no intention to be bound by any expressed or implied theory presented in the preceding technical field, background, brief summary or the following detailed description. Various embodiments of the present invention provide input devices and methods that facilitate improved usability of a touch screen device.

In various embodiments, an input device is formed from conductive traces (i.e., micro-traces) arranged at an angle and periodicity such that the traces are substantially invisible, thus allowing larger assemblies of small traces to form sensor elements that do not substantially diminish the quality of light transmission through the input device. Advantageously, the low-visibility traces can be utilized to form sensor elements in virtually any arbitrary shape, size or orientation, thereby allowing the design of the sensor elements to focus on device performance instead of trying to minimize disruption of light transmission or other undesirable visual effects.

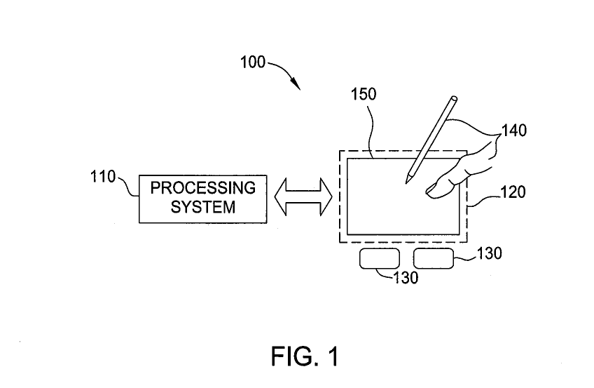

FIG. 1 is a schematic block diagram of an exemplary input device 100, in accordance with embodiments of the invention. The input device 100 may be configured to provide input to an electronic system (not shown). As used in this document, the term “electronic system” (or “electronic device”) broadly refers to any system capable of electronically processing information. Some non-limiting examples of electronic systems include personal computers of all sizes and shapes, such a desktop computers, laptop computers, notebook computers, tablets, web browsers, e-book readers, and personal digital assistants (PDAs). Additional example electronic systems include composite input devices, such as physical keyboards that include input device 100 and separate joysticks or key switches. Further example electronic systems include peripherals such as data input devices (including remote controls, and mice), and data output devices (including display screens and printers). Other examples include remote terminals, kiosks, and video game machines (e.g., video game consoles, portable gaming devices, and the like). Other examples include communication devices (including cellular phones, such as smart phones), and media devices (including recorders, editors, and players such as televisions, set-top boxes, music players, digital photo frames, and digital cameras). Additionally, the electronic system could be a host or a slave to the input device.

The input device 100 can be implemented as a physical part of the electronic system, or can be physically separate from the electronic system. As appropriate, the input device 100 may communicate with parts of the electronic system using any one or more of the following: buses, networks, and other wired or wireless interconnections. Examples include I²C, SPI, PS/2, Universal Serial Bus (USB), Bluetooth, RF, and IRDA.

In FIG. 1, the input device 100 is shown as a proximity sensor device (also often referred to as a “touchpad” or a “touch sensor device”) and includes a sensor device 150 configured to sense input provided by one or more input objects 140 in a sensing region 120. Example input objects include fingers and styli, as shown in FIG. 1.

Sensing region 120 encompasses any space above, around, in and/or near the input device 100 in which the input device 100 is able to detect user input (e.g., user input provided by one or more input objects 140). The sizes, shapes, and locations of particular sensing regions may vary widely from embodiment to embodiment. In some embodiments, the sensing region 120 extends from a surface of the input device 100 in one or more directions into space until signal-to-noise ratios prevent sufficiently accurate object detection. The distance to which this sensing region 120 extends in a particular direction, in various embodiments, may be one the order of less than a millimeter, millimeters, centimeters, or more, and may vary significantly with the type of sensing technology used and the accuracy desired. Thus, some embodiments sense input that comprises no contact with any surfaces of the input device 100, contact with an input surface (e.g., a touch surface) of the input device 100, contact with an input surface of the input device 100 coupled with some amount of applied force or pressure, and/or a combination thereof. In various embodiments, input surfaces may be provided by surfaces of casings within which the sensor electrodes reside, by face sheets applied over the sensor electrodes or any casings, etc. In some embodiments, the sensing region 120 has a rectangular shape when projected onto an input surface of the input device 100.

The input device 100 may utilize any combination of sensor components and sensing technologies to detect user input in the sensing region 120. The input device 100 comprises one or more sensing elements (i.e., sensor electrodes) of the sensor device 150 for detecting user input. As several non-limiting examples, the input device 100 may use ultrasonic, capacitive, elastive, resistive, inductive, surface acoustic wave, and/or optical techniques to provide one or more resulting signals which include positive and negative polarities, the one or more resulting signals including effects indicative of the input object relative to the sensing region.

Some implementations are configured to provide images that span one, two, three or higher dimensional spaces. Some implementations are configured to provide projections of input along particular axes or planes.

In some resistive implementations of the input device 100, a flexible and conductive first layer is separated by one or more spacer elements from a conductive second layer. During operation, one or more voltage gradients are created across the layers. Pressing the flexible first layer may deflect it sufficiently to create electrical contact between the layers, resulting in voltage outputs reflective of the point(s) of contact between the layers. These voltage outputs may be used to determine positional information.

In some inductive implementations of the input device 100, one or more sensing elements pick up loop currents induced by a resonating coil or pair of coils. Some combination of the magnitude, phase, and frequency of the currents may then be used to determine positional information.

In some capacitive implementations of the input device 100, voltage or current is applied to create an electric field. Nearby input objects cause changes in the electric field, and produce detectable changes in capacitive coupling that may be detected as changes in voltage, current, or the like.

Some capacitive implementations utilize arrays or other regular or irregular patterns of capacitive sensing elements to create electric fields. In some capacitive implementations, separate sensing elements may be ohmically shorted together to form larger sensor electrodes. Some capacitive implementations utilize resistive sheets, which may be uniformly resistive.

Some capacitive implementations utilize “self capacitance” (or “absolute capacitance”) sensing methods based on changes in the capacitive coupling between sensor electrodes and an input object. In various embodiments, an input object near the sensor electrodes alters the electric field near the sensor electrodes, thus changing the measured capacitive coupling. In one implementation, an absolute capacitance sensing method operates by modulating sensor electrodes with respect to a reference voltage (e.g. system ground), and by detecting the capacitive coupling between the sensor electrodes and input objects.

Some capacitive implementations utilize “mutual capacitance” (or “transcapacitance”) sensing methods based on changes in the capacitive coupling between sensor electrodes. In various embodiments, an input object near the sensor electrodes alters the electric field between the sensor electrodes, thus changing the measured capacitive coupling. In one implementation, a transcapacitive sensing method operates by detecting the capacitive coupling between one or more transmitter sensor electrodes (also “transmitter electrodes” or “transmitters”) and one or more receiver sensor electrodes (also “receiver electrodes” or “receivers”). Transmitter sensor electrodes may be modulated relative to a reference voltage (e.g., system ground) to transmit transmitter signals. Receiver sensor electrodes may be held substantially constant relative to the reference voltage to facilitate receipt of resulting signals. A resulting signal may comprise effect(s) corresponding to one or more transmitter signals, and/or to one or more sources of environmental interference (e.g. other electromagnetic signals). Sensor electrodes may be dedicated transmitters or receivers, or may be configured to both transmit and receive.

In FIG. 1, the processing system (or “processor”) 110 is shown as a part or subsystem of the input device 100. The processing system 110 is configured to operate the hardware of the input device 100 to detect input in the sensing region 120 utilizing resulting signals provided to the processing system 110 from the sensor device 150. The processing system 110 comprises parts of or all of one or more integrated circuits (ICs) and/or other circuitry components; in some embodiments, the processing system 110 also comprises electronically-readable instructions, such as firmware code, software code, and/or the like. In some embodiments, components composing the processing system 110 are located together, such as near sensing element(s) of the input device 100. In other embodiments, components of processing system 110 are physically separate with one or more components close to sensing element(s) of input device 100, and one or more components elsewhere. For example, the input device 100 may be a peripheral coupled to a desktop computer, and the processing system 110 may comprise software configured to run on a central processing unit of the desktop computer and one or more ICs (perhaps with associated firmware) separate from the central processing unit. As another example, the input device 100 may be physically integrated in a phone, and the processing system 110 may comprise circuits and firmware that are part of a main processor of the phone. In some embodiments, the processing system 110 is dedicated to implementing the input device 100. In other embodiments, the processing system 110 also performs other functions, such as operating display screens, driving haptic actuators, etc.

The processing system 110 may be implemented as a set of modules that handle different functions of the processing system 110. Each module may comprise circuitry that is a part of the processing system 110, firmware, software, or a combination thereof. In various embodiments, different combinations of modules may be used. Example modules include hardware operation modules for operating hardware such as sensor electrodes and display screens, data processing modules for processing data such as sensor signals and positional information, and reporting modules for reporting information. Further example modules include sensor operation modules configured to operate sensing element(s) to detect input, identification modules configured to identify gestures such as mode changing gestures, and mode changing modules for changing operation modes.

In some embodiments, the processing system 110 responds to user input (or lack of user input) in the sensing region 120 directly by causing one or more actions. Example actions include changing operation modes, as well as GUI actions such as cursor movement, selection, menu navigation, and other functions. In some embodiments, the processing system 110 provides information about the input (or lack of input) to some part of the electronic system (e.g., to a central processing system of the electronic system that is separate from the processing system 110, if such a separate central processing system exists). In some embodiments, some part of the electronic system processes information received from the processing system 110 to act on user input, such as to facilitate a full range of actions, including mode changing actions and GUI actions.

For example, in some embodiments, the processing system 110 operates the sensing element(s) of the sensor device 150 to produce electrical signals indicative of input (or lack of input) in the sensing region 120. The processing system 110 may perform any appropriate amount of processing on the electrical signals in producing the information provided to the electronic system. For example, the processing system 110 may digitize analog electrical signals obtained from the sensor electrodes of the sensor device 150. As another example, the processing system 110 may perform filtering or other signal conditioning. As yet another example, the processing system 110 may subtract or otherwise account of a baseline, such that the information reflects a difference between the electrical signals and the baseline. As yet further examples, the processing system 110 may determine positional information, recognize inputs as commands, recognize handwriting, and the like.

“Positional information” as used herein broadly encompasses absolute position, relative position, velocity, acceleration, and other types of spatial information. Exemplary “zero-dimensional” positional information includes near/far or contact/no contact information. Exemplary “one-dimensional” positional information includes positions along an axis. Exemplary “two-dimensional” positional information includes motions in a plane. Exemplary “three-dimensional” positional information includes instantaneous or average velocities in space. Further examples include other representations of spatial information. Historical data regarding one or more of positional information may also be determined and/or stored, including, for example, historical data that tracks position, motion, or instantaneous velocity over time.

In some embodiments, the input device 100 is implemented with additional input components that are operated by the processing system 110 or by some other processing system. These additional input components may provide redundant functionality for input in the sensing region 120, or some other functionality. FIG. 1 shows buttons 130 near the sensing region 120 that can be used to facilitate selection of items using the input device 100. Other types of additional input components include sliders, balls, wheels, switches, and the like. These input components may be part of the sensor device 150. Conversely, in some embodiments, the input device 100 may be implemented with no other input components.

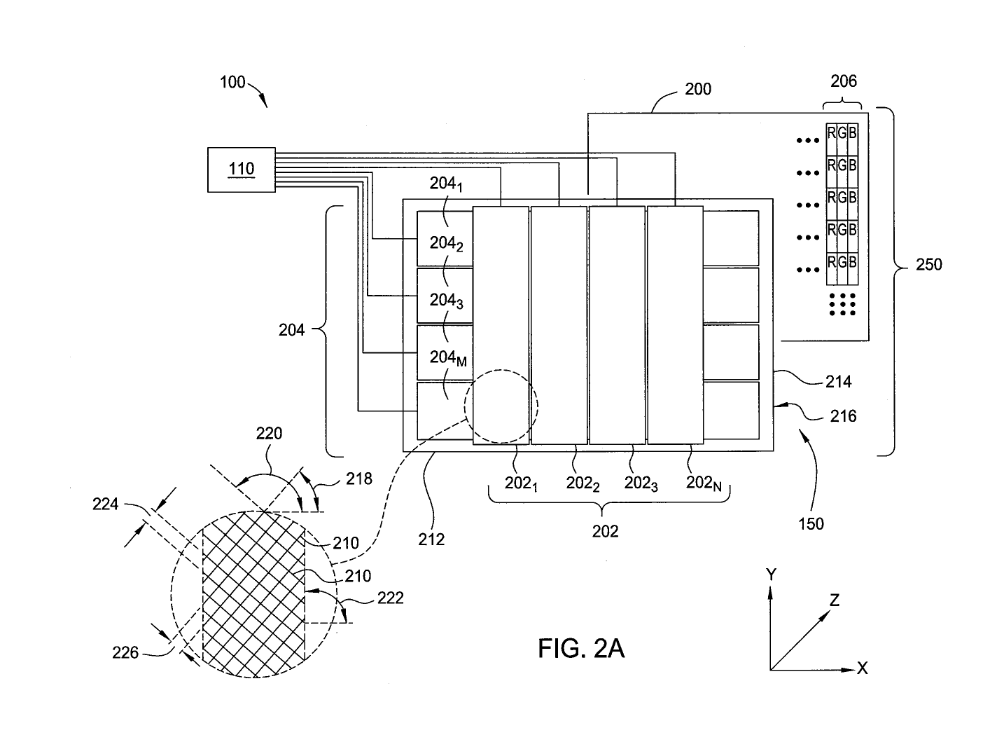

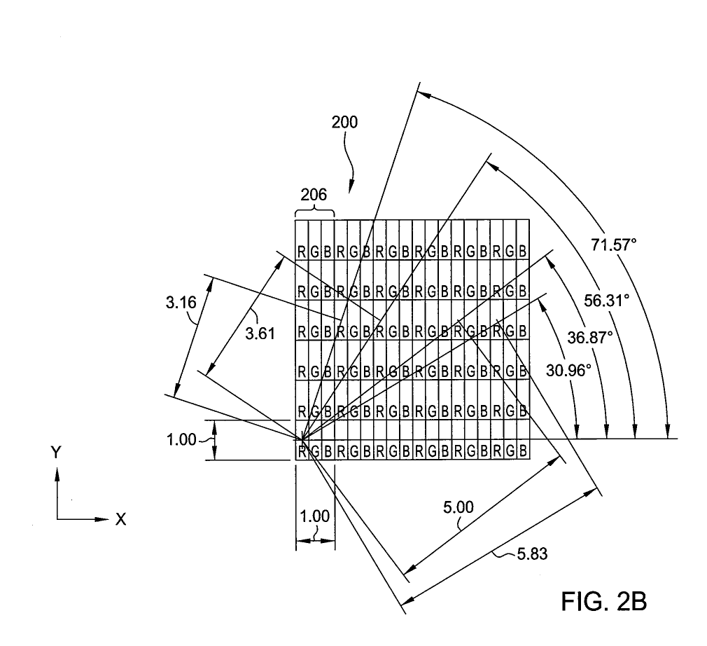

In some embodiments, the input device 100 comprises a touch screen interface, and the sensing region 120 overlaps at least part of an active area of a display screen that is part of a display device 200 shown in FIG. 2 and described further below. For example, the sensor device 150 of the input device 100 may comprise substantially transparent sensor electrodes overlaying the display screen and provide a touch screen interface for the associated electronic system. The display screen may be any type of dynamic display capable of displaying a visual interface to a user, and may include any type of light emitting diode (LED), organic LED (OLED), cathode ray tube (CRT), liquid crystal display (LCD), plasma, electroluminescence (EL), or other display technology. The input device 100 and the display screen may share physical elements. For example, some embodiments may utilize some of the same electrical components for displaying and sensing. As another example, the display screen may be operated in part or in total by the processing system 110.

It should be understood that while many embodiments of the invention are described in the context of a fully functioning apparatus, the mechanisms of the present invention are capable of being distributed as a program product (e.g., software) in a variety of forms. For example, the mechanisms of the present invention may be implemented and distributed as a software program on information bearing storage media that are readable by electronic processors (e.g., non-transitory computer-readable and/or recordable/writable information bearing media readable by the processing system 110). Additionally, the embodiments of the present invention apply equally regardless of the particular type of medium used to carry out the distribution. Examples of non-transitory, electronically readable storage media include various discs, memory sticks, memory cards, memory modules, and the like. Electronically readable storage media may be based on flash, optical, magnetic, holographic, or any other storage technology.

FIG. 2A is an exploded schematic of one embodiment of the sensor device 150 disposed over a display device 200. As discussed above, a portion or all of the sensor device 150 may optionally be incorporated into the display device 200. Together, the input device 100 having the sensor device 150 and the display device 200 may be part of an electronic system 250, examples of which are described above and additionally discussed with reference to FIG. 8 below.

The display device 200 may have monochromatic pixels, each formed from single subpixels, or multi-colored pixels, each formed from multiple subpixels. Three or four subpixels per color pixel are common, with color pixels formed from red-green-blue subpixels, red-green-blue-white subpixels, red-green-blue-yellow subpixels, or some other combination of differently-colored subpixels. In embodiments where the display device 200 includes multiple subpixels per pixel, the display device 200 typically has a pixel pitch along the directions that the display device spans. For example, square or rectangular display screens typically has “X” and “Y” pixel pitches. These pitches may be equal (resulting in square pixels) or not equal. In the embodiment depicted in FIG. 2A, the display device 200 includes an array of square pixels 206 comprised of red (R), green (G), and blue (B) subpixels.

The sensor device 150 includes a plurality of sensor elements, for example, a sensor electrode pattern, configured to sense the presence of (or lack thereof) input objects 140 in the sensing region 120 adjacent the sensor device 150. For clarity of illustration and description, FIG. 2A shows a pattern of simple rectangles, and does not show various components. In various embodiments, the sensor electrode pattern comprises a plurality of first sensor electrodes 202 (202₁, 202₂, 202₃, . . . 202ₙ), and a plurality of second sensor electrodes 204 (204₁, 204₂, 204₃, . . . 204ₘ) disposed under the plurality of second sensor electrodes 202, wherein N and M are positive integers representative of the last electrode in the array, and wherein N may, or may not, equal M. In the embodiment depicted in FIG. 2A, the second sensor electrodes 204 are linear and parallel to each other. Likewise, the first sensor electrodes 202 are linear and parallel to each other, and oriented perpendicular to the second sensor electrodes 204. It is also contemplated that the sensor electrodes 202, 204 may have different orientations.

In a transcapacitive configuration, the first sensor electrodes 202 and second sensor electrodes 204 may be configured to sense the presence of (or lack thereof) input objects 140 in the sensing region 120 adjacent the sensor device 150 by driving a signal onto one of the sensor electrodes (i.e., transmitter electrode), while at least one of the other sensor electrodes is configured as a receiver electrode. The capacitive coupling between the transmitter sensor electrodes and receiver sensor electrodes change with the proximity and motion of input objects (140 shown in FIG. 1) in the sensing region 120 associated with the first and second sensor electrodes 202, 204. By monitoring the capacitive coupling between the transmitter sensor electrodes and receiver sensor electrodes, the location and/or motion of the input object 140 may be determined.

Alternatively in an absolute sensing configuration, first sensor electrodes 202 and second sensor electrodes 204 may be configured to sense the presence of input objects 140 in the sensing region 120 adjacent the sensor device 150 based on changes in the capacitive coupling between sensor electrodes 202, 204 and an input object 140. For example, the sensor electrodes 202, 204 may be modulated with respect to a reference voltage (e.g. system ground), and by detecting the capacitive coupling between the sensor electrodes 202, 204 and input objects, the location and/or motion of the input object 140 may be determined. In other embodiments, other sensing methods may be used, including but not limited to, optical sensing, resistive sensing, acoustic wave sensing, ultrasonic sensing and the like.

In some touch screen embodiments, first sensor electrodes 202 comprise one or more common electrodes (e.g., “V-com electrode”) used in updating the display of the display device 200. These common electrodes may be disposed on an appropriate display screen substrate of the display device 200. For example, the common electrodes may be disposed on the TFT glass in some display screens (e.g., In-Plane Switching (IPS) or Plane to Line Switching (PLS)), on the bottom of the color filter glass of some display screens (e.g., Patterned Vertical Alignment (PVA) or Multi-domain Vertical Alignment (MVA)), etc. In such embodiments, the common electrode can also be referred to as a “combination electrode”, since it performs multiple functions. In various embodiments, each first sensor electrode 202 comprises one or more common electrodes. In other embodiments, at least two first sensor electrodes 202 may share at least one common electrode.

At least one of the sensor electrodes 202, 204 comprises one or more conductive traces having a diameter less than about 10 um. In the embodiment depicted in FIG. 2A, a portion of the first sensor electrode 202₁ is enlarged such that conductive traces 210 are shown. In various embodiments, the conductive traces 210 may be fabricated from a material sufficiently conductive enough to allow charging and discharging of the sensor electrodes 202, 204. Examples of materials suitable for fabricating the conductive traces 210 include ITO, aluminum, silver and copper, among others. The conductive traces 210 may be fabricated from opaque or non-opaque materials, and may be one of a metal mesh and/or thin metal wires. Suitably conductive carbon materials may also be utilized. Advantageously, using metallic materials for the conductive traces 210 provides much lower electrical resistance as compared to substantially transparent conductors, thereby improving device performance. Additionally, by arranging the traces 210 in an orientation that is substantially invisible and/or produces an acceptable moiré pattern, the width of the traces 210 may be increased, thereby allowing simpler and more efficient processing.

The conductive traces 210 are arranged with at least one of an angle and periodicity selected to render the traces substantially invisible. This allows a number of small traces 210 to be locally grouped to form larger sensor elements (such as the second sensor electrode 204 illustrated in FIG. 2A) in any arbitrary shape, size and orientation. In this manner, the first sensor electrode 202 (and/or similarly constructed second sensor electrode 204) may be linear, curved, circular, polygonal or other desirable geometric shape.

As mentioned above, the angle of individual traces 210 relative to the axes of the display device 200 will also affect the visibility of the traces 210. Not all of the traces 210 grouped to form a single sensor electrode need have the same angular orientation, as long as combined arrangement of the traces 210 will not detrimentally affect the visibility of an image displayed on the display device 200. Thus, in many embodiments, the traces 210 are predominantly orientated at angles selected to reduce the visibility of the moiré patterns that may result.

In the embodiment depicted in FIG. 2A, the axes of pixels 206 comprising the display device 200 are aligned with the X and Y coordinate axes, as are lateral edges 212, 214 of a transparent substrate 216 on which the second sensor electrodes 204 of the sensor device 150 is disposed. Thus, primary angles 218, 220 of individual traces 210 thus may be referenced relative to one of the lateral edges, for example edge 212, which is aligned with the axis of the pixels 206. The angles 218, 220 of individual traces 210 in which the traces 210 may be rendered substantially invisible may be determined by a variety of methods. For example, one method to render the traces 210 substantially invisible is to rotate a physical embodiment of the sensor pattern and visually identify angle(s) that results in an acceptable or optimal subjective appearance. As another example, the spatial frequencies for color aliasing between the display and the opaque traces may be calculated to determine the angles and/or the trace pitches that reduce the calculated visibility. Examples of how to calculate the spatial frequencies are described in literature on human vision, for example, “Contrast Sensitivity of the Human Eye and its Effects on Image Quality” by Peter G. J. Barten. As yet another example, geometric construction may be utilized to choose a path for the traces that passes over red, green, and blue subpixels in a sequence that results in an acceptable or optimal subjective appearance. Generally, the angles 218, 220 which provide a substantially invisible appearance need not be at a maximum value of the spatial frequency for a given trace 210 and pixel 206. It has been found that angles 218, 220 that produce a moiré pattern having a spatial frequency greater than about 10 cycles per centimeter may be as much as 70 percent less than the maximum value of the spatial frequency for a given trace 210 and pixel 206 combination and still provide an acceptable visual effect.

In the embodiment depicted in FIG. 2A, the angle 218 of the traces 210 may be at an orientation relative to the edge 212 (and the first orientation of pixels 206 (e.g., aligned with the X axis) comprising the display device 200) that is within about +/−5 degrees of an orientation that provides maximized spatial frequency. In another embodiment, the angle 218 of the traces 210 may be, but not limited to, any one of about 30, 36, 56, or 71 degrees +/− about 5 degrees relative to the edge 212 (and the first orientation of pixels 206 (e.g., aligned with the X axis) comprising the display device 200). Although the first sensor electrodes 202 of the sensor device 150 in the embodiment depicted in FIG. 2A is disposed at an angle 222 that is perpendicular to the X axis and edge 212 of the sensor device 150, the angle 222 of the first sensor electrodes 202 may be disposed at angles other than 90 degrees.

In the embodiment depicted in FIG. 2A, the angle 220 of the traces 210 may be at an orientation relative to the edge 212 (and the first orientation of pixels 206 (e.g., aligned with the X axis) comprising the display device 200) that is within about +/−5 degrees of an orientation that provides maximized spatial frequency. In another embodiment, the angle 220 may be, but not limited to anyone of about 109, 124, 144, or 150 degrees +/− about 5 degrees relative to the edge 212 (and the first orientation of pixels 206 (e.g., aligned with the X axis) comprising the display device 200).

Adjacent traces 210 having the same angular orientation (e.g., either angle 218 or angle 220) may have a spacing (i.e., periodicity) 224, 226 selected to render the traces substantially invisible. In one embodiment, not all of adjacent traces 210 are spaced similarly. It has been found that spacing 224 that produces a moiré pattern having a spatial frequency greater than about 10 cycles per centimeter may be as much as 70 percent less than the maximum value of the spatial frequency for a given trace 210 and pixel 206 combination and still provide an acceptable visual effect. In various embodiments, the second sensor electrodes 204 may be fabricated using in a similar manner using conductive traces as described above in reference to the first sensor electrodes 202.

It is noted that both the spacing 224 and angles 220, 222 may be selected together to produce the above effects. The conductive traces 210 may also be oriented using any one or combination spacing 224 and angles 220, 222 relative to plurality of pixels 206 form a moiré pattern with the display device 200, wherein said moiré pattern comprises a pitch in a direction parallel to the first orientation smaller than the pitch of 3 cycles of pixels 206.

FIG. 2B illustrates a plurality of rotational angles for sensor electrodes (sensor electrodes 204 and/or sensor electrodes 202) and/or traces 210 having a high spatial repeat frequency in relation to a plurality of pixels 206 indicated by subpixels R (red subpixels), G (green subpixels) and B (blue subpixels). While four angles for the sensor electrodes and/or traces 210 are shown; 71.57 degrees, 56.31 degrees, 36.87 degrees and 30.96 degrees, these are not meant to be limiting examples, and other rotational angles are possible. In one example, the four angles shown may have a tolerance of at least +/−5 degrees. The plurality of rotational angles are based on square shaped pixels 206 (e.g., Px=Py, or in other words, a pixel height to width ratio of 1) and, in other embodiments, the pixels may have other shapes and corresponding rotational angles. Further, while FIG. 2B illustrates a plurality of repeated R (Red), G (Green) and B (Blue) subpixels, in other embodiments, other subpixels and subpixels groupings may be used. In such embodiments, the rotational angles of the sensor electrodes and/or traces 210 are at least partially based on the pixels 206 and subpixels groupings. In one embodiment the rotational angle is determined based on equation 1.

$$Angle = ATAN \frac{j \times Px}{k \times Py} for j , k \{ 1 , 2 , 3 , … \} and j \neq k \qquad Equation 1$$

The variables j and k may be of any choice, but use of smaller values for the variables j and k will desirably result in to higher spatial frequency.

Further, FIG. 2B illustrates a plurality of repeat distances shown in units of pixels for pixels having a height to width ratio of 1. In one embodiment, the repeat distance is related to how often a subpixel of the same color is crossed along a selected rotational angle. For example, for a rotation angle of 71.57 degrees, the repeat distance is about 3.16 pixels, meaning that for every 3.16 pixels, a red, green or blue subpixel is crossed. The repeat distances illustrated in FIG. 2B are illustratively measured from the center of the subpixels. The corresponding repeat distances for each of other sensor electrode and/or trace angles are also shown in FIG. 2B. In one embodiment, the repeat distance is greater than one pixel. In a further embodiment, the repeat distance is less than ten pixels. In yet another embodiment, the repeat distance is selected from a range between one pixel and ten pixels. For a given pixel orientation, the repeat distance may be determined based on equation 2.

RepeatDistance=\sqrt{(j×Px)²+(k×Py)²} Equation 2

Further the spatial frequency may be determined based on equation 3.

$$SpatialFrequency = \frac{1}{\sqrt{{( j \times Px )}^{2} + {( k \times Py )}^{2}}} \qquad Equation 3$$

As can be seen from equations 2 and 3 above, the spatial frequency increases as the repeat distance decreases. In various embodiments, the plurality of sensor electrodes (sensor electrodes 204 and/or sensor electrodes 202 and/or traces 210) is disposed such that they have a rotational angle having a high spatial frequency. For example, the sensor electrodes and/or traces 210 may be disposed along any of the illustrated angles. In some embodiments, the conductive traces forming the sensor electrodes are disposed such that they have a rotational angle having a high spatial frequency. In other embodiments, angle 218 and angle 220 are selected to have a high spatial frequency as described above. In various embodiments, the sensor electrodes and/or the conductive traces of the sensor electrodes may be disposed along multiple rotational angles. For example, the sensor electrodes and/or the conductive traces of the sensor electrodes may be disposed in a pattern that weaves along at least two different rotational angles or has a lattice, such as depicted in FIG. 2A. In one embodiment, the pattern may consist of sensor electrodes and/or conductive traces being disposed for a certain distance along first angle and then a second distance along a second angle that are mirrors of each other (i.e., 56.31 degrees and 123.69 degrees) or selected such that they have high spatial frequency but are not mirrors of each other. In one embodiment, a first plurality of sensor electrodes may be disposed along a first rotational angle and a second plurality of sensor, electrodes may be disposed along a second rotational angle. In such embodiments, a high spatial frequency corresponds to a spatial frequency of greater than about 10 cycles per centimeter. In various embodiments, the spatial frequency corresponding to the orientation is at least 30% of its maximum value.

The sensor electrode pitch may be selected such that for a given area of the display device, the sensor electrode does substantially occlude multiple subpixels of the same color. For example, in one embodiment, the pitch should be selected such that multiple subpixels of the same color in a column of subpixels are not substantially occluded as compared to subpixels in an adjacent column.

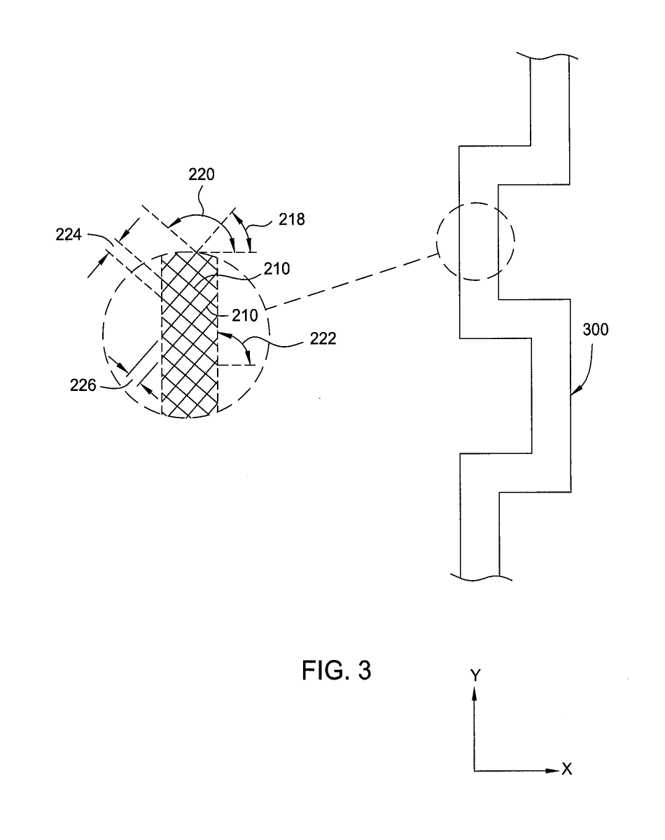

FIG. 3 is a plan view of another embodiment of a sensor electrode 300 of which may be utilized in the sensor device 150. For example, either one or both of the sensor electrodes 202, 204 may be constructed as the sensor electrode 300 described below.

The sensor electrode 300 may have a generally linear form long its entire length (i.e., in the Y-direction) without adjacent portions of the electrode being linear aligned (i.e., adjacent portions of the electrode displaced in the X-direction). For example, the sensor electrode 300 may have a square wave form, a sinusoidal form, a wavy form, a zig-zagged form or other globally linear yet macroscopically non-linear form. The sensor electrode 300 may be formed from a single trace 210, or alternatively, from a plurality of interconnected traces 210, similar to the first sensor electrode 202 as described above.

The sensor electrode 300 may have an orientation of perpendicular to one of the lateral edges 212, 214 of the transparent substrate 216 on which the sensor electrode 300 of the sensor device 150 is disposed. Optionally, the sensor electrode 300 (and/or traces 210 comprising the sensor electrode 300) may have an orientation which render the sensor electrode 300 substantially invisible. For example, the sensor electrode 300 (and/or traces 210 comprising the sensor electrode 300) may be oriented at an angle relative to one of the lateral edges 212, 214 selected to produce a moiré pattern having a spatial frequency greater than about 10 cycles per centimeter, and even may be as much as 70 percent less than the maximum value of the spatial frequency for a given sensor electrode 300 (and/or trace 210) and pixel 206 combination and still provide an acceptable visual effect.

In the embodiment, the sensor electrode 300 (and/or traces 210 comprising the sensor electrode 300) is disposed at an orientation relative to the edge 212 (and the first orientation of pixels 206 (e.g., aligned with the X axis) comprising the display device 200) that is within about +/−5 degrees of an orientation that provides maximized spatial frequency. It is contemplated that certain embodiments will have some conductive traces 210 orientated at about a first angle and some conductive traces 210 orientated at a second angle.

When the sensor electrode 300 is comprised of a plurality of conductive traces 210, the conductive traces 210 forming the sensor electrode 300 may be arranged as described above with reference to the conductive traces 210 comprising the first sensor electrode 202.

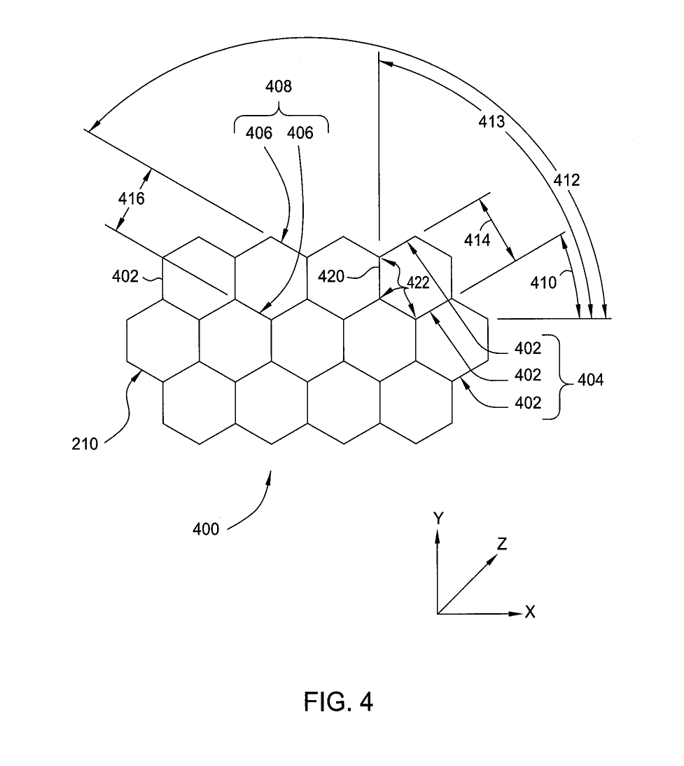

FIG. 4 is a plan view of another embodiment of a sensor electrode 400 of which may be utilized in the sensor device 150. For example, either one or both of the sensor electrodes 202, 204 may be constructed as the sensor electrode 400 described below. The sensor electrode 400 is formed from a plurality of interconnected traces 210. The sensor electrode 400 may have a generally linear form long its entire length (i.e., in the X-direction), and may optionally include adjacent portions which are not linear aligned, such as shown and described with reference to the sensor electrode 300 of FIG. 3. For example, the sensor electrode 400 may have a square wave form, a sinusoidal form, a wavy form, a zig-zagged form or other globally linear yet macroscopically non-linear form.

The sensor electrode 400 may have an orientation of perpendicular to one of the lateral edges 212, 214 of the transparent substrate 216 on which the sensor electrode 400 of the sensor device 150 is disposed. Optionally, the sensor electrode 400 may have an orientation which renders the sensor electrode 400 substantially invisible. For example, the sensor electrode 400 may be oriented at an angle relative to one of the lateral edges 212, 214 selected to produce a moiré pattern having a spatial frequency greater than about 10 cycles per centimeter, and even may be as much as 70 percent less than the maximum value of the spatial frequency for a given sensor electrode 400 and pixel 206 combination and still provide an acceptable visual effect.

In the embodiment, the sensor electrode 400 is disposed at an orientation relative to the edge 212 (and the first orientation of pixels 206 (e.g., aligned with the X axis) comprising the display device 200) that is within about +/−5 degrees of an orientation that provides maximized spatial frequency.

In one embodiment, the sensor electrode 400 has an orientation of substantially perpendicular to one of the lateral edges 212, 214 of the transparent substrate 216, while the traces 210 comprising the sensor electrode 400 have an orientation which render the sensor electrode 400 substantially invisible. For example, the traces 210 comprising the sensor electrode 400 may be oriented at an angle relative to one of the lateral edges 212, 214 selected to produce a moiré pattern having a spatial frequency greater than about 10 cycles per centimeter, and even may be as much as 70 percent less than the maximum value of the spatial frequency for a given sensor electrode 400 and pixel 206 combination and still provide an acceptable visual effect.

In the embodiment, the traces 210 comprising the sensor electrode 400 are disposed at an orientation relative to the edge 212. (and the first orientation of pixels 206 (e.g., aligned with the X axis) comprising the display device 200) that is within about +/−5 degrees of an orientation that provides maximized spatial frequency. Further, the conductive traces 210 comprising the sensor electrode 400 may be disposed such that angle 413 of a trace 420 comprising the traces 210 is greater than or less than 90 degrees relative to the the x-axis (which typically is in alignment with one of the pixel axis as seen in FIGS. 2A-2B. Thus, in some embodiment, all traces 210 may have an orientation that is not in alignment with the x-axis and/or y-axis. In some embodiments, at least two of the interior angles 422 defined by a polygon shape defined by contiguous traces 210 may be unequal. In one embodiment, the conductive traces 210 comprising the sensor electrode 400 are disposed such that angles, 410, 412, 413 each is a rotational angle having a high spatial frequency.

The spacing between neighboring first traces 402 and between neighboring second traces 406 may also be selected to render the sensor electrodes 400 substantially invisible. In one embodiment, not all of adjacent traces 210 comprising the sensor electrode 400 are spaced similarly. Spacing 416 of the second traces 406 may be similar to that of the first traces 402.

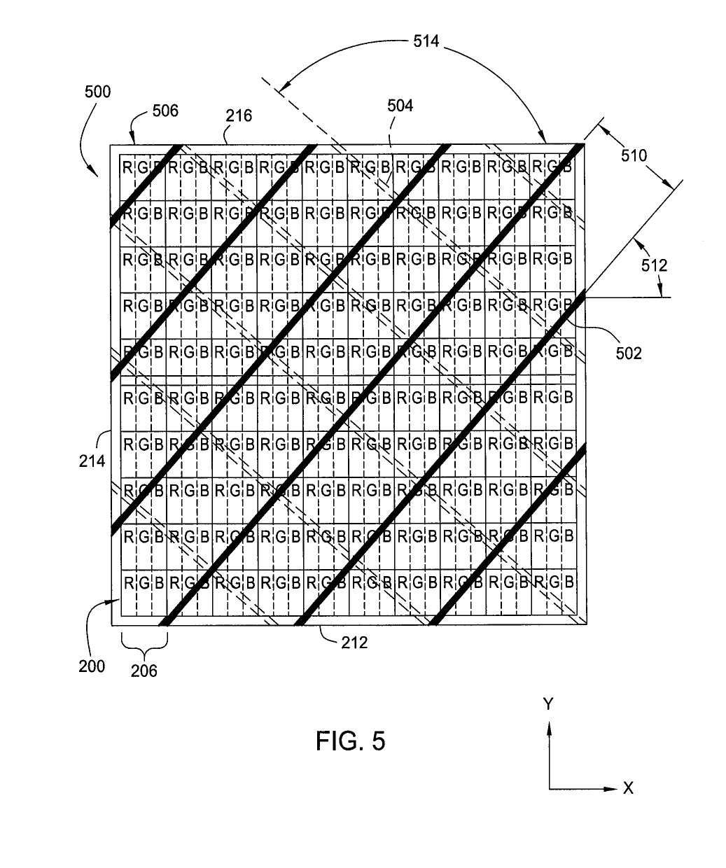

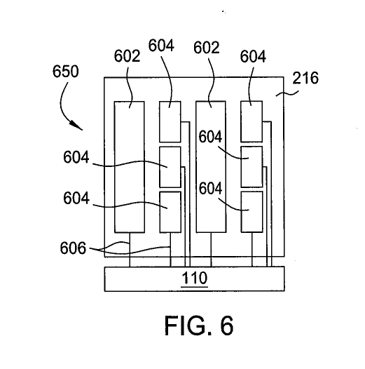

FIG. 5 is a plan view of another embodiment of an input device 500 having a sensor device 506, in accordance with embodiments of the invention. A display device 200 having a plurality of pixels 206 are illustrated below the sensor device 506. The sensor device 506 may be disposed external to, internal to, or share at least one electrode with the display device 200 as described herein.

In the embodiment depicted in FIG. 5, the sensor device 506 includes a plurality of first sensor electrodes 502 and a plurality of second sensor electrodes. The plurality of second sensor electrodes may have any suitable configuration, including comprising segments of the segmented V-com electrode (common electrodes) of the display device 200. In the embodiment depicted in FIG. 5, the plurality of second sensor electrodes are designated using reference numeral 504, illustrating that the plurality of second sensor electrodes 504 have an orientation substantially perpendicular to the plurality of first sensor electrodes 502, although alternative configurations may be utilized.

The first sensor electrode 502 may be an individual trace, identical to the traces 210 described herein, or may be a group of traces forming an individual sensor electrode, identical in construction to the first sensor electrodes described above. At least one of a spacing 510 and primary angle 512 of the first sensor electrodes 502 is selected to produce a moiré pattern with the display devise 200 having a spatial frequency greater than about 10 cycles per centimeter. In one embodiment, at least one of the spacing 510 and angle 512 of the first sensor electrodes 502 is selected to rendered the first sensor electrodes 502 substantially invisible. In another embodiment, at least one the spacing 510 and angle 512 of the first sensor electrodes 502 is selected to produce a moiré pattern having a spatial frequency greater than about 10 cycles per centimeter which also is as much as 70 percent less than the maximum value of the spatial frequency for a given first sensor electrode 502 and pixel 206 combination and still provide an acceptable visual effect. The orientation of the first sensor electrode 502, either through spacing 510, angle 512 or combination thereof, may also be selected relative to plurality of pixels 206 form a moiré pattern with the display device 200, wherein said moiré pattern comprises a pitch in a direction parallel to the first orientation smaller than the pitch of 3 cycles of pixels 206.

In the embodiment depicted in FIG. 5, the angle 512 of each first sensor electrodes 502 is aligned relative to a first orientation of the pixels 206 of the display device 200, here illustrated parallel to an edge 212 of a transparent substrate 216 on which the first sensor electrode 502 are formed, also parallel with the X coordinate axis. The angle 512 may be at an orientation relative to the edge 212 (and the first orientation of pixels 206 (e.g., aligned with the X axis) comprising the display device 200) that is within about +/−5 degrees of an orientation that provides maximized spatial frequency.

In the embodiment depicted in FIG. 5, the second sensor electrodes 504 are disposed at a primary angle 514 relative to the edge 212 (and the first orientation of pixels 206 (e.g., aligned with the X axis) comprising the display device 200) that is within about +/−5 degrees of an orientation that provides maximized spatial frequency. Although the second sensor electrodes 504 of the sensor device 506 in the embodiment depicted in FIG. 5 is disposed perpendicular to the first sensor electrodes 502, the second sensor electrodes 504 may be disposed at angles other than 50 degrees.

The spacing. (i.e., periodicity) 510 of adjacent first sensor electrodes 502 may also be selective to render the first sensor electrodes 502 substantially invisible. In one embodiment, not all of adjacent first sensor electrodes 502 are spaced similarly.

While FIG. 5 illustrates a plurality of substantially parallel sensor electrodes 502 and 504, the sensor electrodes 502 and 504 may have other shapes, sizes and configurations. For example, sensor electrodes 502 and 504 may comprise a shape or configuration similar to those depicted in FIGS. 2A, 3 and 4.

FIG. 6 is a plan view of an alternative embodiment of a sensor device 650 which may be utilized in the input device 100 described herein. The sensor device 650 is substantially similar to the sensor device 150 described herein, except wherein first sensor electrodes 602 and second sensor electrodes 604 are disposed co-planar in a common single layer disposed on a transparent substrate 216. In many embodiments, the first sensor electrodes 602 and second sensor electrodes 604 are coupled to a processing system 110 utilizing conductive routing wires 606, a portion of which are disposed within (i.e., co-planar with) the common single layer disposed on the transparent substrate 216. At least one or both of the first sensor electrodes 602 and second sensor electrodes 604 are fabricated using conductive traces 210 as described herein with reference to the first sensor electrode 202. In one embodiment configured for transcapacitive sensing, second sensor electrodes 604 may be configured as receiver electrodes and first sensor electrodes 602 may be configured as transmitter electrodes. While FIG. 6 illustrates one example embodiment, it is not meant to be limiting, and in other embodiments the sensor electrode shapes may comprise different shapes, sizes and configurations.

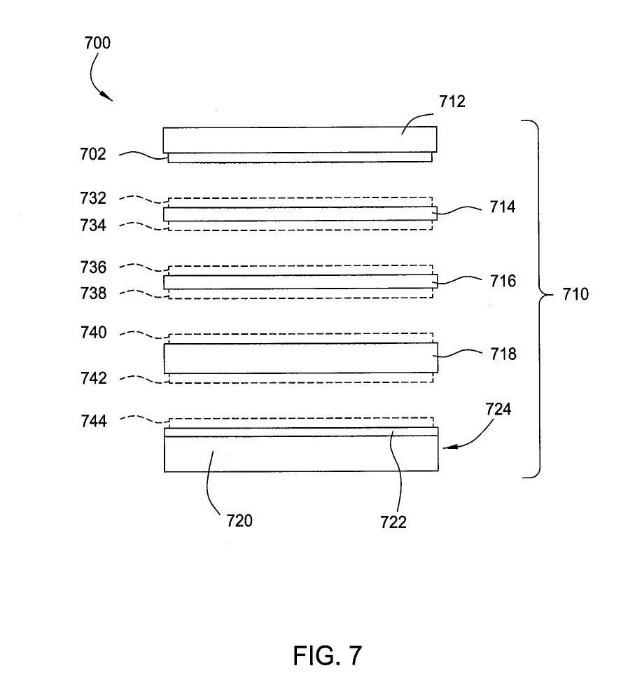

FIG. 7 is an exploded view of an electronic system 710 (i.e., a display device) having an input device 700 disposed at least partially within the electronic system 710. The electronic system 710 may be one of the various types of electronic systems described herein, among others. The input device 700 is similar to the input device 100, and includes a sensor device 702 that may be within or external to an adjacent display device 200. The exploded view of the electronic system 710 allows various alternative positions of the sensor device 702 to be illustrated within the electronic system 710. The sensor device 702 include at least one sensor electrode fabricated with conductive traces 210 as described herein with reference to the first sensor electrode 202, and may be configured as any of the sensor devices 150, 650, 750, 950 described herein, or other suitable configuration.

The electronic system 710 generally includes a display device interfaced with a sensor device that is configured to sense input provided by one or more input objects 140 in a sensing region 120, as illustrated in FIG. 1.

The electronic system 710 generally includes a plurality of transparent substrates positioned over a substrate 722 (i.e., TFT Glass) of an active element 724 of the display device. In one embodiment, a plurality of transparent substrates positioned over the substrate 722 of the display device 200 includes a lens 712, an optional polarizer 714, an optional anti-shatter film 716, and a color filter glass (CFG) 718. In one embodiment, the sensor device 702 is disposed at least partially on one of these transparent substrates, and/or on the substrate 722 of the display device 200. In the embodiment depicted in FIG. 7, the sensor device 702 is shown disposed on a lower surface (i.e. surface facing substrate 722 of the active element 724) of the lens 712.

The sensor device 702 may be configured as any of the sensor devices described herein, and may be disposed on (1) a separate transparent substrate (e.g., transparent substrate 216), (2) at least partially on or fully formed one of the substrates 712, 714, 716, 718, or (3) at least partially on, fully formed on, or within the active element 724 of the display device.

Additionally shown in FIG. 7 are alternative positions (shown in phantom) for locating the sensor device 702 within the electronic system 710. For example, the sensor device 702 may be positioned on, at least partially formed directly on, or fully formed directly on an upper side of the optional polarizer 714, as illustrated by reference numeral 732. The sensor device 702 may alternatively be positioned on, at least partially formed directly on, or fully formed directly on a lower side of the optional polarizer 714, as illustrated by reference numeral 734. The sensor device 702 may alternative be positioned on, at least partially formed directly on, or fully formed directly on an upper side of the optional anti-shatter film 716, as illustrated by reference numeral 736. The sensor device 702 may alternatively be positioned on, at least partially formed directly on, or fully formed directly on a lower side of the optional anti-shatter film 716, as illustrated by reference numeral 738.The sensor device 702 may alternative be positioned on, at least partially formed directly on, or fully formed directly on an upper side of the CFG 718, as illustrated by reference numeral 740. The sensor device 702 may alternatively be positioned on, at least partially formed directly on, or fully formed directly on a lower side of the CFG 718, as illustrated by reference numeral 742.

The sensor device 702 may alternative be positioned on, at least partially formed directly on, or fully formed directly on an upper side of the substrate of the active element 724, as illustrated by reference numeral 744. Where the sensor device 702 is formed as least partially formed directly on, formed fully on, or within the substrate of the active element 724 of the display device; one or both of the first or second electrodes of the sensor device 702 may be comprised of common electrodes (segments of segmented V-com electrode 720).

In a transcapacitive sensing mode of operation, sensing of an input object relative to a sensing region of may be practiced using the input devices described herein. Sensing of an input object relative to a sensing region of the input device begins by driving a transmitter signal on at least one of the plurality of transmitter sensor electrodes of the sensor device. The processing system receives the resulting signal from at least one of the plurality of receiver sensor electrodes. The resulting signal includes effects corresponding to the transmitter signal which is indicative of the presence, or lack thereof, of an input object relative to the sensing region of the input device. The processing system determines positional information for the object in the sensing region of the input device from the resulting signals. Alternatively, an absolute sensing mode, optical sensing mode, resistive sensing mode, acoustic sensing mode an ultrasonic sensing mode of operation or the like, may be practiced using the input devices described herein, among other sensing techniques utilizing sensing electrodes disposed over a display device.

Thus, input device having a plurality of low-visibility sensor electrodes and method for using the same are provided. The traces and/or sensor electrodes are arranged in a manner for minimum pattern perceptibility. In some embodiment, the traces may be electrically connected to one another to form macroscopic (e.g., a single larger) sensor element which, by virtue of the low-visibility traces utilized to form the sensor element, can be configured in virtually any arbitrary shape, size or orientation while will not detrimentally effecting the visibility of an image displayed on the display device adjacent the sensing region.

What is claimed is:

1. An input device comprising:
a display device; and
a plurality of sensor electrodes disposed over the display device and configured to sense objects in a sensing region of the input device, wherein the plurality of sensor electrodes comprise a plurality of spaced apart conductive traces, each conductive trace having a diameter less than about 10 um, the conductive traces disposed such that the conductive traces form a moiré pattern with the display device, wherein said moiré pattern comprises a spatial frequency greater than about 10 cycles per centimeter.

2. The input device of claim 1, wherein the conductive traces comprise an opaque material.

3. The input device of claim 1, wherein the conductive traces comprise one of a metal mesh and thin metal wires.

4. The input device of claim 1, wherein the conductive traces are disposed on at least one transparent substrate external to the display device.

5. The input device of claim 1, wherein the at least some of the conductive traces are disposed on a transparent substrate internal to the display device.

6. The input device of claim 1, wherein each of the plurality of sensor electrodes have a linear orientation.

7. The input device of claim 1, wherein the conductive traces comprising each of the plurality of sensor electrodes comprise an orientation such that each of the plurality of sensor electrodes is substantially invisible.

8. The input device of claim 7, wherein the spatial frequency corresponding to the orientation is at least 30% of its maximum value.

9. The input device of claim 7, wherein the orientation is within +/−5 degrees of an angle that provides a maximized spatial frequency.

10. The input of claim 1, wherein a combined moiré pattern of a first subset of the plurality of sensor electrodes and a second subset of the plurality of sensor electrodes has a high spatial frequency.

11. An input device comprising:
a display device; and
a sensing device having a plurality of first sensor electrodes and a plurality of second sensor electrodes and configured to sense objects in a sensing region adjacent the displace device, wherein at least one of the first sensor electrodes and the second sensor electrodes comprise conductive traces having a diameter less than about 10 um, the conductive traces disposed such that the conductive traces form a moiré pattern with the display device, wherein said moiré pattern comprises a spatial frequency greater than 10 cycles per centimeter.

12. The input device of claim 11, wherein the conductive traces comprises an opaque material.

13. The input device of claim 11, wherein the conductive traces comprises one of a metal mesh and thin metal wires.

14. The input device of claim 11, wherein the conductive traces are disposed on at least one transparent substrate external to the display device or are disposed on a transparent substrate internal to the display device.

15. The input device of claim 11, wherein the conductive traces comprising each of the plurality of sensor electrodes comprise an orientation such that each of the plurality of sensor electrodes is substantially invisible.

16. The input device of claim 15, wherein the spatial frequency corresponding to the orientation is at least 30% of its maximum value.

17. The input device of claim 15, wherein the orientation is an angle within at least +/−5 degrees of an orientation that provides a maximized spatial frequency.

18. The input of claim 11, wherein a combined moiré pattern of a first subset of the plurality of sensor electrodes and a second subset of the plurality of sensor electrodes has a high spatial frequency.

19. An input device comprising:
a display device comprising a plurality of pixels having a first orientation and second orientation orthogonal to the first orientation; and
a plurality of sensor electrodes disposed over the display device and configured to sense an object in a sensing region of the input device, wherein the plurality of sensor electrodes comprise a plurality of spaced apart conductive traces, each conductive trace having a diameter less than about 10 um, the conductive traces oriented relative to plurality of pixels form a moiré pattern with the display device, wherein said moiré pattern comprises a pitch in a direction parallel to the first orientation smaller than the pitch of 3 cycles of pixels.

20. The input device of claim 19 further comprising:
a processing system coupled to the plurality of sensor electrodes, wherein the plurality of sensor electrodes comprise a plurality of transmitter sensor electrodes a plurality of receive electrodes, the processing system configured to:
drive a transmitter signal on at least one of the plurality of transmitter sensor electrodes;
receive a resulting signal from at least one of the plurality of receiver sensor electrodes, the resulting signal comprising effects corresponding to the transmitter signal; and
determine positional information for an object in the sensing region of the input device.
